(19) United States
(12) Patent Application Publication
(10) Pub. No.: US 2025/0355559 A1
(43) Pub. Date: Nov. 20, 2025

(54) DATA DE-DUPLICATION USING CONTENT-ADDRESSABLE MEMORY SEARCH

(71) Applicant: Micron Technology, Inc., Boise, ID (US)

(72) Inventors: Steven Wells, Sacramento, CA (US); Tomoko Ogura Iwasaki, San Jose, CA (US); Manik Advani, Fremont, CA (US)

(21) Appl. No.: 19/210,725

(22) Filed: May 16, 2025

Related U.S. Application Data
(60) Provisional application No. 63/649,079, filed on May 17, 2024.

(51) Int. Cl. G06F 3/06

(52) U.S. Cl. CPC G06F 3/0608; G06F 3/0641; G06F 3/0679

(57) ABSTRACT

Various embodiments provide for using data search on content-addressable memory (CAM), such as CAM implemented using a NOT-AND (NAND)-type memory device, to facilitate data de-duplication, where the CAM and the data search can be part of a memory system (e.g., memory sub-system).

### PRIORITY APPLICATION

This application claims the benefit to U.S. Provisional Application Ser. No. 63/649,079, filed May 17, 2024, which is incorporated herein by reference in its entirety.

### TECHNICAL FIELD

Example embodiments of the disclosure relate generally to memory devices and, more specifically, to using data search on content-addressable memory (CAM) to facilitate data de-duplication, where the CAM can be part of a memory system (e.g., memory sub-system).

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram illustrating an example computing system that includes a memory sub-system, in accordance with some embodiments of the present disclosure.

FIG. 2 is a block diagram illustrating details of an example content-addressable memory (CAM) implemented on a NAND-type memory device within a memory sub-system, which can be used for data de-duplication in accordance with some embodiments of the present disclosure.

FIG. 3 illustrates components of a CAM block implemented in the exemplary form of a NAND-type flash memory device, in accordance with some embodiments of the present disclosure.

FIG. 4 illustrates a single CAM cell of the CAM block implemented within a NAND flash memory device, in accordance with some embodiments of the present disclosure.

FIGS. 5 and 6 illustrate flow diagrams of example methods for using data search on CAM to facilitate data de-duplication, in accordance with some embodiments of the present disclosure.

FIG. 7 is a block diagram illustrating an example of using data search on CAM to facilitate data de-duplication in an example data center environment, in accordance with some embodiments of the present disclosure.

FIG. 8 is a block diagram of an example computer system in which embodiments of the present disclosure may operate.

### DETAILED DESCRIPTION

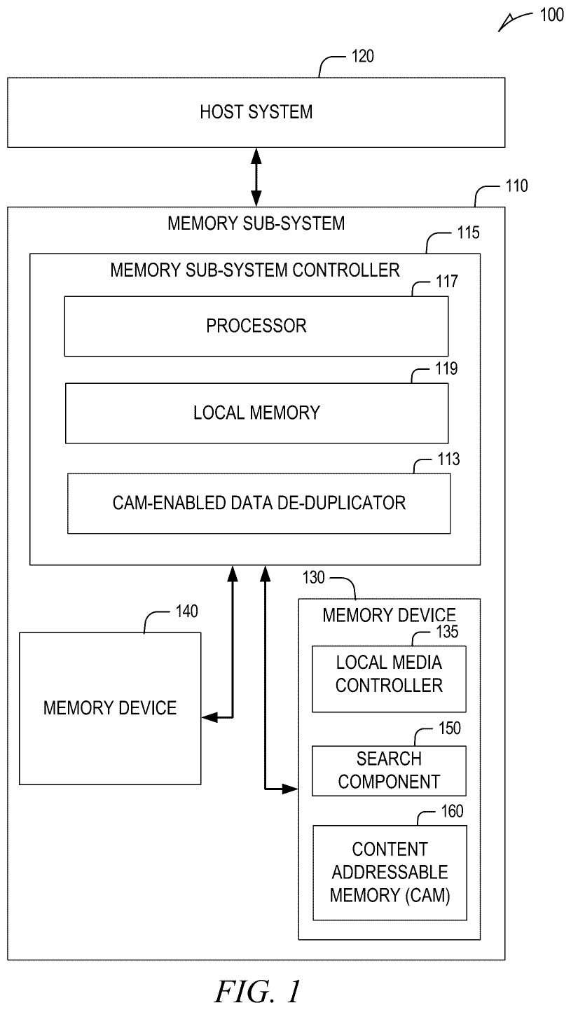

Aspects of the present disclosure are directed to using data search on content-addressable memory (CAM), such as CAM implemented using a NOT-AND (NAND)-type memory device, to facilitate data de-duplication, where the CAM and the data search can be part of a memory system (e.g., memory sub-system). A memory system using CAM to facilitate data de-duplication, as described herein, can be particularly useful in data center applications, such as facilitating data de-duplication at a front-end or edge server of a data center. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write commands, read commands) to the memory sub-system, such as to store data on a memory device at the memory sub-system, read data from the memory device on the memory sub-system, or write/read constructs with respect to a memory device on the memory sub-system. The data to be read or written, as specified by a host request (e.g., data access request or command request), is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., error-correcting code (ECC) codeword, parity code), data version (e.g., used to distinguish age of data written), valid bitmap (which LBAs or logical transfer units contain valid data), and so forth.

The memory sub-system can initiate media management operations, such as a write operation on host data that is stored on a memory device or a scan (e.g., media scan) of one or more blocks of a memory device. For example, firmware of the memory sub-system can re-write previously written host data from a location of a memory device to a new location as part of garbage collection management operations. The data that is re-written, for example as initiated by the firmware, is hereinafter referred to as “garbage collection data.”

“User data” hereinafter generally refers to host data and garbage collection data. “System data” hereinafter refers to data that is created and/or maintained by the memory sub-system for performing operations in response to host requests and for media management. Examples of system data include, and are not limited to, system tables (e.g., logical-to-physical memory address mapping table (also referred to herein as an L2P table), data from logging, scratch pad data, and so forth).

A memory device can be a non-volatile memory device. A non-volatile memory device is a package of one or more die. Each die (e.g., NAND-type memory device die) can comprise one or more physical planes (or planes). Groupings of planes can be organized according to logic units (LUNs), with each individual logic unit (LUN) being associated with a different grouping of planes. For some types of non-volatile memory devices (e.g., NOT-AND (NAND)-type memory devices), each plane comprises a set of physical blocks. For some memory devices, blocks are the smallest area that can be erased. Each block comprises a set of pages. Each page comprises a set of memory cells, which store bits of data. The memory devices can be raw memory devices (e.g., NAND), which are managed externally, for example, by an external controller. The memory devices can be managed memory devices (e.g., managed NAND), which are raw memory devices combined with a local embedded controller for memory management within the same memory device package.

Generally, writing data to such memory devices involves programming (by way of a program operation) the memory devices at the page level of a block, and erasing data from such memory devices involves erasing the memory devices at the block level (e.g., page level erasure of data is not possible). Certain memory devices, such as NAND-type memory devices, comprise one or more blocks, (e.g., multiple blocks) with each of those blocks comprising multiple pages, where each page comprises a subset of memory cells of the block, and where a single wordline of a block (which connects a group of memory cells of the block together) defines one or more pages of a block (depending on the type of memory cell). Depending on the embodiment, different blocks can comprise different types of memory cells. For instance, a block (a single-level cell (SLC) block) can comprise multiple SLCs, a block (a multi-level cell (MLC) block) can comprise multiple MLCs, a block (a triple-level cell (TLC) block) can comprise multiple TLCs, a block (a quad-level cell (QLC) block) can comprise QLCs, and a block (a penta-level cell (PLC) block) can comprise PLCs. Other blocks comprising other types of memory cells (e.g., higher-level memory cells, having higher bit storage-per-cell) are also possible.

Each worldline (of a block) can define one or more pages depending on the type of memory cells (of the block) connected to the wordline. For example, for an SLC block, a single wordline can define a single page. For a MLC block, a single wordline can define two pages-a lower page (LP) and an upper page (UP). For a TLC block, a single wordline can define three pages-a lower page (LP), an upper page (UP), and an extra page (XP). For a QLC block, a single wordline can define four pages-a lower page (LP), an upper page (UP), an extra page (XP), and a top page (TP) page. As used herein, a page of LP page type can be referred to as a “LP page,” a page of UP page type can be referred to as a “UP page,” a page of XP page type can be referred to as a “XP page,” and a page of TP page type can be referred to as a “TP page.” Each page type can represent a different level of a cell (e.g., QLC can have a first level for LPs, a second level for UPs, a third level for XPs, and a fourth level for TPs). To write data to a given page, the given page is programmed according to a page programming algorithm (e.g., that causes one or more voltage pulses or pulses to memory cells of a block based on the memory).

The problem of data duplication is a common issue for data storage systems, especially with respect to data centers. It is not unusual for large files or large sections of files stored on a data storage system (e.g., in a filesystem or a database system) to be identical. The storage of such identical (or duplicate) data can occupy unnecessary data storage space on various data storage systems (e.g., in a data center of a social media company), which in turn can increase capital expenditure. Additionally, transferring duplicate data across a data communication network (e.g., between a front-end or edge server of a data center and a data backup server at a data backup storage facility) can consume extra data bandwidth, which in turn can affect the performance of the data communication network and lead to additional capital expenditure (e.g., for operating data centers and data backup storage facilities).

De-duplication is a technique commonly used to eliminate duplicate copies of repeated data. De-duplication is typically applied to a set of data objects, such as files or blocks of data, and involves analyzing data objects to identify and remove redundant data. In particular, when multiple instances of the same data are found during data object analysis, de-duplication will cause storage of only one copy of the data object and cause the creation of references (e.g., pointers) to the unique copy for all subsequent instances of the data object. De-duplication can be particularly effective in environments where there is a lot of redundancy, such as front-end/edge servers in a data center environment that use an external data backup or data archival system. De-duplication can also be beneficial in reducing the amount of data that needs to be transferred over a data communication network (e.g., from a front-end/edge server to a data backup server), where de-duplication would result in only unique data being sent after de-duplication.

In the context of large-scale data centers (e.g., hyperscaler environments), the need for efficient de-duplication becomes even more critical. Such large-scale data centers handle an enormous volume of data, with object searches potentially reaching the order of 10\hat{ }8 per day across a dataset comprising upwards of 10\hat{ }11 data objects. Managing such a vast amount of data, while maintaining high performance and quick data access times, can be challenging.

The traditional approach to de-duplication involves comparing data objects or “data chunks” of data objects (e.g., 4 KB words) to detect duplicate data objects or duplicate data chunks. The comparison process can comprise computing a unique identifier (e.g., hash value) for each of the data objects/data chunks being analyzed for de-duplication; the unique identifier can be generated using a hash function, such as a cryptographic hash function (e.g., SHA-256). Where a hash value is generated as the unique identifier, the hash value ideally has a one-to-one mapping with the data object/data chunk. The unique identifier can then be compared against a database of existing unique identifiers associated with currently stored (or previously transferred) data objects/data chunks. If there is a match, the data object/data chunk can be considered a duplicate and the duplicate data object/data chunk can be replaced with a reference (e.g., link or the unique identifier) to an existing copy of the data object/data object.

While comparing unique identifiers (e.g., hash values) instead of actual data objects/data chunks to perform data de-duplication can save time and computational resources, generating and comparing unique identifiers using a hardware processor (e.g., central processing unit (CPU) of a front-end/edge server) can still be computationally intensive and time-consuming, especially when dealing with the scale of data found in large-scale data centers. As such, in conventional data center implementations, data de-duplication is not performed on front-end/edge servers (e.g., at data centers) but, rather, performed at data backup servers (e.g., at data backup storage facilities), as the cost and overhead of performing de-duplication on front-end/edge servers can be prohibitively high. Generally, front-end/edge servers transfer data to data backup servers, and the data backup servers perform the de-duplication. However, this approach to data de-duplication (performing data de-duplication at only the data backup servers) not only results in extra data storage costs (e.g., capital and power costs) on both the front-end/edge servers and the data backup servers, but also results in more data traffic being transferred from the front-end/edge servers to the data backup servers, which results in extra data communication costs (e.g., capital and power cost to cover provide sufficient bandwidth on data transmission channels). Accordingly, it would beneficial to have a data de-duplication solution that permitted data de-duplication at a source where data is being generated or used (such as at front-end/edge servers of a data center), while avoiding the compute overhead (e.g., intense CPU burden) that is typical of performing conventional data de-duplication at the data source. Such a solution would not only enable a reduction in data being transferred across a data communication network (e.g., to a minimum data amount) and save data bandwidth but also reduce storage and power costs.

Various embodiments presented herein can cure these and other deficiencies of conventional methodologies for data de-duplication, especially with respect to data used or stored at data center environments. In particular, various embodiments presented herein provide for using data search on content-addressable memory (CAM) to facilitate a data de-duplication process, where the CAM and the data search can be part of a memory system (e.g., memory sub-system). For various embodiments, a CAM architecture implemented on a NAND-type memory device is used within a memory system (e.g., memory sub-system) to enable or facilitate the process by which a data de-duplication process (e.g., an existing data de-duplication process) determines whether duplicate data (e.g., data objects) exists. The use of an embodiment can increase the speed with which a data de-duplication process detects duplicate data, and can further offload the process of detecting duplicate data, from a hardware processor (e.g., CPU) of a computer system, to a processor and CAM of a memory system (e.g., memory sub-system) that is operatively coupled to the computer system. By offloading duplicate data detection from the hardware processor of the computer system to the processor and CAM of the memory system, at least some of the compute load of performing a data de-duplication process (e.g., the compute load of performing duplicate data detection) can be absorbed by the memory system (e.g., using the processor and the CAM thereof), which can lead to significant performance advantage in performing data de-duplication.

An embodiment described herein can be agnostic to the overall data de-duplication process in which the embodiment is used. For instance, within an existing data de-duplication process, conventional duplicate data detection using a CPU is replaced with duplicate data detection by a memory system that uses a CAM to detect duplicate data. The remainder of the existing data de-duplication process can remain the same.

According to some embodiments, a memory system (e.g., memory sub-system) comprises content-addressable memory (CAM), and a processor of the memory system: generates unique identifiers (e.g., hash values) with respect to data objects already stored on non-content-addressable memory (non-CAM); and stores the generated unique identifiers (e.g., hash values) on the CAM. In this way, the CAM can be used to maintain a table of unique identifiers (e.g., a hash table) that correspond to stored data objects, where the table can be subsequently searched for a unique identifier to determine whether a duplicate of a certain data object is already stored. For various embodiments, the CAM is implemented on a NAND-type memory device (e.g., NAND-CAM). Depending on the embodiment, the non-CAM memory can be part of the memory system, or can be external to the memory system (e.g., on another memory sub-system). During a data de-duplication process, to determine whether a select data object is a duplicate of a data object that is currently stored (e.g., on non-CAM memory of the memory system), the processor of the memory system can generate a select unique identifier (e.g., select hash value) for the select data object, can search the CAM for the select unique identifier. If the processor finds a match, the select data object can be determined to be duplicate data (e.g., data that is already stored on the non-CAM), which is eligible for de-duplication by the data de-duplication process). For example, in response to the select data object being determined to be duplicate data, the data de-duplication process can cause storage of the select data object to be skipped or cause the select data object. For such data objects (e.g., which are deleted or for which storage is skipped), the data de-duplication process can use the select unique identifier (or a reference to the stored data object) to be used in place of the select data object.

Use of some embodiments can address the performance demands of large-scale data systems (e.g., large-scale data centers) by accelerating the search and comparison of unique identifiers (e.g., data object hashes) associated with stored data objects, which can enable quick determination of whether a data object is unique or already stored within the data system. With respect to data center applications, use of some embodiments can enable performance of de-duplication at a data source (where data is generated or used) and, in doing so, can permit data de-duplication to be applied early in a data processing pipeline (e.g., to be applied at the data ingress process), which can provide benefits in terms of reducing the amount of data that needs to be stored, managed, or transferred (e.g., for data backup purposes). In this way, various embodiments enable edge-based de-duplication in scenarios where network bandwidth is limited or where reducing the computational load on edge devices is desired.

Generally, CAM is a special type of memory used in certain high-speed searching applications, such as identifier (ID) and pattern matching. Generally, a CAM is searched by comparing input search data against a table of stored data entries and a memory address of matching data in the table is returned. Some embodiments described herein use a CAM implemented on a NAND-type memory device. For various embodiments, a CAM implemented on a NAND-type memory device facilities search of unique identifiers (e.g., hash values) using high-speed and high-density pattern matching. Additionally, CAMs implemented on a NAND-type memory device have higher storage capacity than CAMs implemented on non-NAND-type memory devices (e.g., those implemented in dynamic random-access memory (DRAM), synchronous random-access memory (SRAM), or the like), thereby enabling storage and search of a very large number unique identifiers (e.g., hash values). For some embodiments, a CAM is implemented on a NAND-type memory device by storing data entries on strings of a NAND-type flash memory array. Unlike CAMs implemented on non-NAND-type memory devices (e.g., those implemented in DRAM or SRAM), each bit of a data entry is mapped to a pair of memory cells that are configured to be complementary. That is, a first memory cell of the pair stores a bit value and a second memory cell of the pair stores an inverse of the bit value. A search pattern representing an input search word is input vertically on each word line corresponding to a string in the array. A single read operation compares the input search word with all strings in the array and identifies a storage address of matching data.

As used herein, a data object can comprise a file or a portion thereof, a database object or a portion thereof, a word of data, a superblock of data, a block of data, or a page of data.

Disclosed herein are some examples of using data search on content-addressable memory (CAM) to facilitate data de-duplication, as described herein.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random-access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130 can include one or more arrays of memory cells. One type of memory cell, for example, SLCs, can store one bit per cell. Other types of memory cells, such as MLCs, TLCs, and QLCs, can store multiple or fractional bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks. As used herein, a block comprising SLCs can be referred to as a SLC block, a block comprising MLCs can be referred to as an MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or crasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or another suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands, requests, or operations from the host system 120 and can convert the commands, requests, or operations into instructions or appropriate commands to achieve the desired access to the memory devices 130 and/or the memory device 140. The memory sub-system controller 115 can be responsible for other operations such as wear leveling operations, garbage collection operations, error detection and ECC operations, encryption operations, caching operations, and address translations between a logical address (e.g., LBA, namespace) and a physical memory address (e.g., physical block address) that are associated with the memory devices 130. The memory sub-system controller 115 can further include host interface circuitry to communicate with the host system 120 via the physical host interface. The host interface circuitry can convert the commands received from the host system 120 into command instructions to access the memory devices 130 and/or the memory device 140 as well as convert responses associated with the memory devices 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device.

The memory sub-system 110 also includes a search component 150 that facilitates searching of content-addressable memory (CAM) 160, which can comprise one or more CAM blocks. Consistent with some embodiments, the search component 150 is included in the in the memory device 130, as shown. In some embodiments, the controller 115 includes at least a portion of the search component 150. For example, the controller 115 can include the processor 117 (processing device) configured to execute instructions stored in the local memory 119 for performing the operations of the search component 150 described herein. In some embodiments, the search component 150 is part of the host system 120, an application, or an operating system.

The search component 150 generates a search pattern based on a received input search word (e.g., unique identifier being searched) and inputs the search pattern vertically along search lines of a CAM block of the CAM 160. If a data entry matching the input search word is stored (e.g., a matching unique identifier is found) by the CAM block, the search pattern causes a match line storing the data entry (also referred to as a “matched line”) to become conductive and since the match lines are pre-charged, a matched line provides a signal to a connected page buffer that indicates that the search word is stored thereon. A location (e.g., a storage address) of any matching data entry may be identified based on the signal provided by the matched line as a result of the string being conductive. More specifically, a page buffer connected to any matched line stores a datum in response to detecting a discharge signal that indicates that the matched datum is stored along the matched line. A component of the search component 150 (e.g., a read-out circuit) may read data from the page buffer. Based on the data read from the page buffer, the search component 150 outputs an indication of whether the search word is stored by the CAM block of the CAM 160 and an indicator of the location of the match line.

The memory sub-system controller 115 includes a content-addressable memory (CAM)-enabled data de-duplicator 113 that enables or facilitates the memory sub-system controller 115 to use data search on content-addressable memory (CAM) to facilitate data de-duplication in accordance with various embodiments described herein.

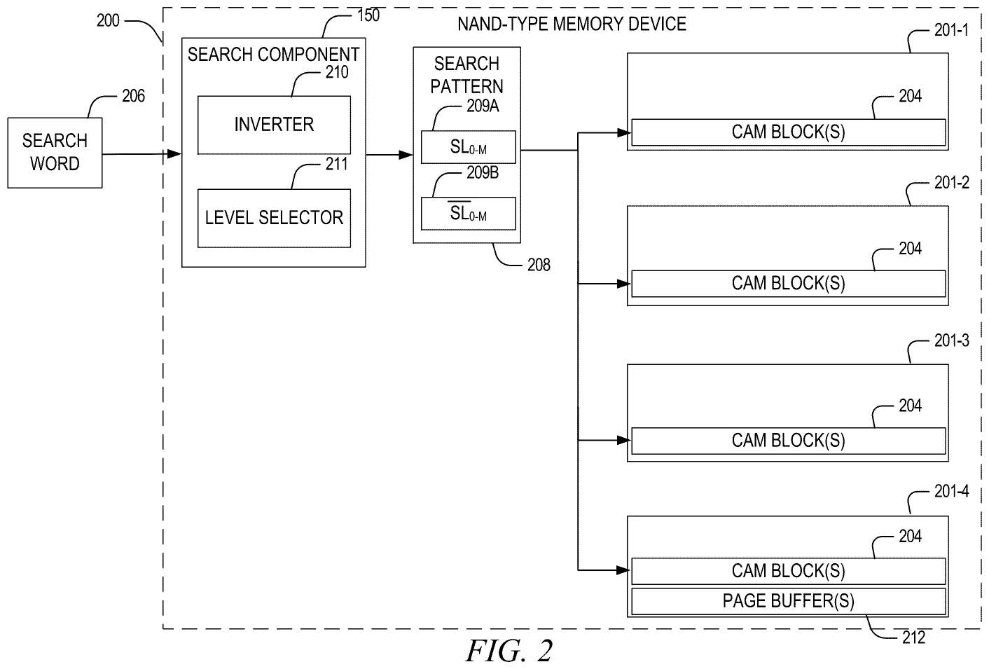

FIG. 2 is a block diagram illustrating details of an example CAM implemented on a NAND-type memory device 200 within the memory sub-system 110, which can be used for data de-duplication in accordance with some embodiments of the present disclosure. As shown in FIG. 2, the NAND-type memory device 200 may be organized into multiple planes-planes 201-1 to 201-4. The NAND-type memory device 200 is an example of one of the memory device 130. Although FIG. 2 illustrates the NAND-type memory device 200 as comprising four planes, it shall be appreciated that the NAND-type memory device 200 is not limited to four planes, and in other embodiments, may comprise more or fewer planes. Each of the planes 201-1 to 201-4 are configured to include one or more CAM blocks 204. The number of CAM blocks 204 per plane may be configured via software or hardware.

As shown, the search component 150 receives an input search word 206 and generates a search pattern 208 based on the input search word 206. The input search word 206 comprises a first sequence of bits (e.g., “1011”). The search pattern 208 generated by the search component 150 comprises a first set of voltage signals 209A (SLO-M) representing the input search word and a second set of voltage signals 209B (SL 0-M) representing a second sequence of bits comprising an inverse of the first sequence of bits (e.g., “0100”). The search component 150 comprises an inverter 210 to generate an inverse of the input search word and a level selector 211 to generate the first and second signals. In generating the first and second voltage signals, the level selector 211 may use voltage Vhigh to represent a binary value of “1” and use a voltage Vlow to represent a binary value of “0” where Vhigh is above a threshold voltage (Vt) and Vlow, is below it.

To search one of the CAM blocks 204, the search component 150 inputs the search pattern 208 vertically along search lines of the one of the CAM blocks 204 being searched. Input of the search pattern 208 causes any complementary memory cell pairs representing a matching stored bit value to become conductive. If a string is storing matching data, the entire string becomes conductive. Match lines in the CAM block 204 are pre-charged (e.g., connected to Vhigh), and because the match lines are pre-charged, input of the search pattern 208 on the search lines causes any match lines in the block that are storing matching data (e.g., a data entry that is identical to the search word 206) to output a discharge signal because the corresponding string is conductive. The discharge signal provides an indication that matching data (e.g., the input search word 206) is stored thereon. The discharge signal provides an indication that matching data is stored on the string connected to the match line.

Each string is connected between a match line and a page buffer (e.g., comprising one or more latch circuits) and the page buffer of a matched line stores data indicating matching data is stored along the matched line in response to the signal provided as a result of the match line discharging along the string. As shown, plane 201-4 includes page buffer(s) 212. A page buffer 212 may comprise one or more latch circuits. Physically, the page buffer(s) 212 reside under or adjacent to the arrays of memory cells in which CAM block(s) 204 are implemented. A page buffer 212 latches data based on the signal provided by a matched line when matching data is stored by the connected string that conducts the signal to the page buffer 212. The search component 150 reads data from the page buffer(s) 212 and provides an indicator of whether the input search word 206 is stored in the one of the CAM blocks 204 being searched as output along with a location of the matching data (e.g., a memory address of the string in the array).

In some embodiments, the search component 150 may sequentially search for matching data in the CAM block(s) 204 of the planes 201-1 to 201-4. That is, the search component 150 may initially search CAM block(s) 204 of the plane 201-1, thereafter search CAM block(s) 204 of the plane 201-2, thereafter search CAM block(s) 204 of the plane 201-3, and finally search CAM block(s) 204 of the plane 201-4.

In some embodiments, the search component 150 may search for matching data in the CAM block(s) 204 of the planes 201-1 to 201-4 in parallel. That is, the search component 150 may simultaneously search all CAM block(s) 204 of the planes 201-1 to 201-4 to find matching data. Parallel searching of the planes 201-1 to 201-4 allows all data entries stored among all CAM block(s) 204 of the planes 201-1 to 201-4 to be searched in a single search operation rather than completing the search of all data entries in four separate search operations. Hence, parallel searching, as utilized in the embodiments described above, may allow the search component 150 to achieve an increase to search speed relative to embodiments in which sequential searching is utilized.

In some embodiments, data entries may be stored across two or more of the planes 201-1 to 201-4. In these instances, the search component 150 may simultaneously search for portions of matching data across two or more of the planes 201-1 to 201-4. Dividing data entries across planes allows for greater word size when compared to embodiments in which data entries are stored within a single plane. For example, if each of the CAM blocks 204 supports 64-bit words, dividing the data entries among all four planes would allow the memory device 200 to support 256-bit words (4*64-256).

To avoid obscuring the inventive subject matter with unnecessary detail, various functional components that are not germane to conveying an understanding of the inventive subject matter have been omitted from FIG. 2. However, a skilled artisan will readily recognize that various additional functional components may be included as part of the memory sub-system 110 to facilitate additional functionality that is not specifically described herein. For example, the memory sub-system 110 may comprise additional circuitry (e.g., one or more multiplexers) that allows for conventional read and write operations to be performed with respect to any one of more of the memory device 130.

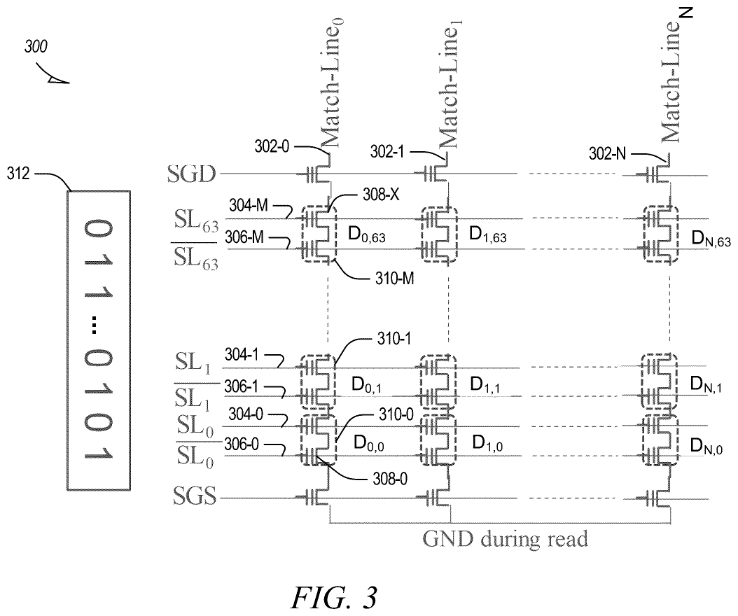

FIG. 3 illustrates components of a CAM block 300 implemented in the exemplary form of a NAND-type flash memory device, in accordance with some embodiments of the present disclosure. The CAM block 300 is an example of the CAM block 204.

As shown, the CAM block 300 comprises match lines 302-0 to 302-N, search lines 304-0 to 304-M, and inverse search lines 306-0 to 306-M. In this implementation, the match lines 302-0 to 302-N of the CAM block 300 correspond to bit lines of the NAND-type flash memory device and the search lines 304-0 to 304-M and inverse search lines 306-0 to 306-M of the CAM block 300 correspond to word lines of the NAND-type flash memory device.

Each of the match lines 302-0 to 302-N is connected to a string comprising a plurality of memory cells connected in series. For example, match line 302-0 is connected to a string comprising memory cells 308-0 to 308-X, where X=2M. Memory cells in each string of the CAM block 300 are configured to be complementary pairs. For example, with the string connected to match line 302-0, memory cells 308-0 to 308-X are programmed as complementary memory cell pairs 310-0 to 310-M.

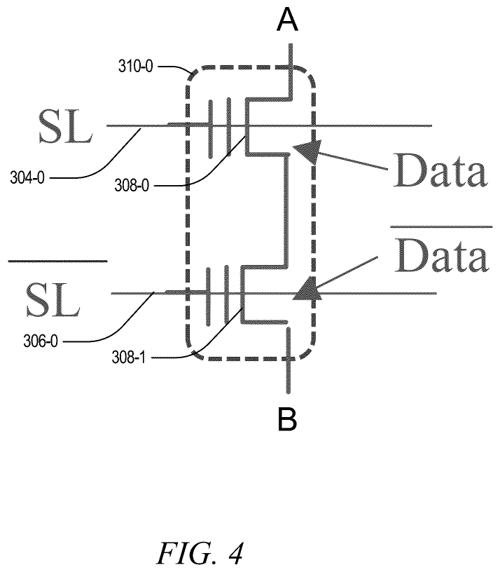

Memory cell pairs are configured to be complementary in that one memory cell in the pair stores a data value (“0”) and the other memory cell in the pair stores an inverse of the data value (“1”). For example, as shown in FIG. 4, memory cell pair 310-0 (CAM cell) comprises two memory cells 308-0 and 308-1. Memory cell 308-0 stores a data bit value DATA, and memory cell 308-1 stores DATA, which is an inverse of the data bit value DATA. Also, as shown, search line 304-0 is connected to a control gate of the memory cell 308-0 and inverse search line 306-0 is connected to a control gate of the memory cell 308-1.

Search line 304-0 receives a first signal SL representing a search bit value from an input search word and inverse search line 306-0 receives a second signal SL representing an inverse of the search bit value. If SL matches DATA and SL matches DATA, the memory cell pair 310-0 will be conductive from A to B. For example, TABLE 1 provided below is a truth table that defines the behavior of any given one of the memory cell pairs 310-0 to 310-M.

TABLE 1

| SL | SL | DATA | DATA | CONDUCTIVE |
|---|---|---|---|---|
| 0 | 1 | 0 | 1 | Yes |
| 0 | 1 | 1 | 0 | No |
| 1 | 0 | 0 | 1 | No |
| 1 | 0 | 1 | 0 | Yes |

In TABLE 1, “SL” is a search bit value, “SL” is an inverse of the search bit value, “DATA” is a stored bit value, and “DATA” is an inverse of the stored bit value. As shown, a complementary cell pair is conductive when the search data value matches the stored data value and the inverse of the search data value matches the inverse of the stored data value. In other instances, the memory cell pair 310 is non-conductive because the stored data does not match the search bit.

Returning to FIG. 3, each string in the CAM block 300 stores a data entry and each data bit value in a data entry is mapped to one of the memory cell pairs 310-0 to 310-M in the string. In this way, within each of the complementary memory cell pairs 310 in a string, a first memory cell stores a bit value from the data entry and a second memory cell stores an inverse of the bit value from the data entry.

In an example where the NAND-type flash memory device supports 128 bit strings (i.e., X is 128), the match line 302-0 is connected to memory cells 308-0 to 308-127, which stores 64 bit data entry comprising bit values D0,0-D63,63. In this example, bit value D0,0 is mapped to memory cell pair 310-0 comprising memory cells 308-0 and 308-1. More specifically, memory cell 308-0 stores the bit value D0,0 and the complementary memory cell 308-1 stores D 0,0, which is the inverse of the bit value D0,0.

A search pattern 312 may be input vertically along search lines 304-0 to 304-M and inverse search lines 306-0 to 306-M. More specifically, search lines 304-0 to 304-M receive a first set of voltage signals SL0-M representing a search word 206, and inverse search lines 306-0 to 306-M receive a second set of voltage signals SL 0-M representing an inverse of the search word. Input of the search pattern 312 along the search lines causes any string that stores matching data to be conductive because, as discussed above, each individual memory cell pair 310 in the string will be conductive. Because the match lines 302 are pre-charged, a conductive string allows the match line 302 to discharge. A page buffer 212 connected to a conductive string latches data that indicates a location of matching data (i.e., the search word 206) in the CAM block 300.

The search component 150 outputs an indication of whether a search word 206 is stored by the CAM block 300 and an indicator of the location (e.g., a memory address) of the matching data. In some embodiments, the search component 150 comprises a read-out circuit that reads data from the page buffers 212 of the CAM block 300 to identify the location thereof.

In some embodiments, two page buffers 212 in the CAM block 300 may be tied together to form a serial shift register. Consistent with these embodiments, the search component 150 shifts data out of a first page buffer to a second page buffer and the search component 150 comprises an output compare and counter component to track the number of shifts from one page buffer to the other to identify the location of matching data stored by the CAM block 300.

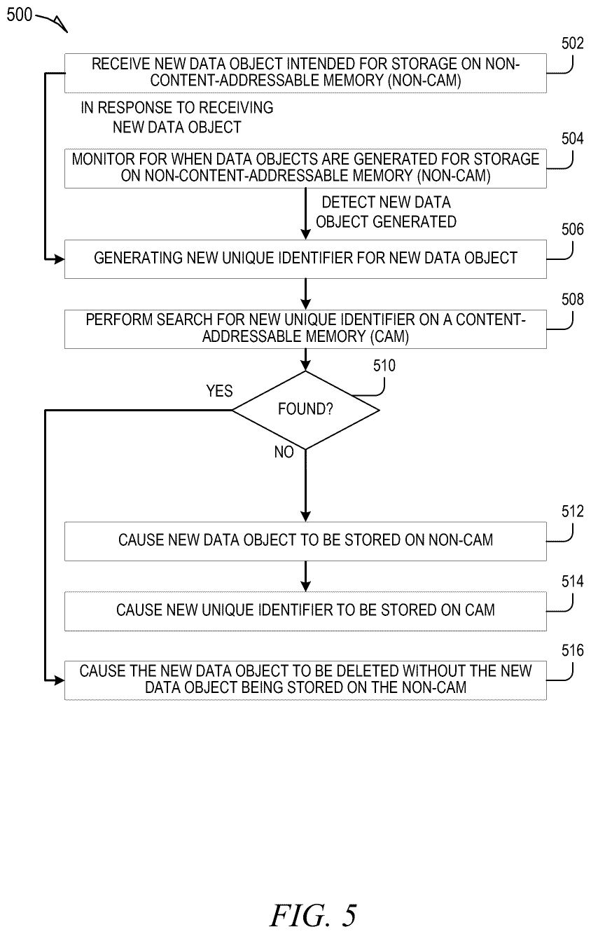

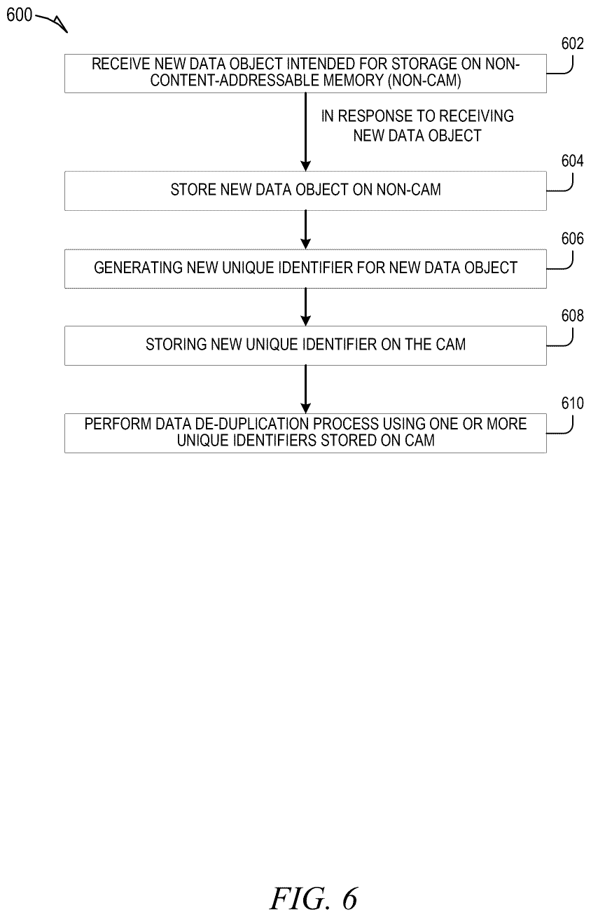

FIGS. 5 and 6 illustrate flow diagrams of example methods 500, 600 for using data search on CAM to facilitate data de-duplication, in accordance with some embodiments of the present disclosure. Any of methods 500, 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, at least some portion of method 500 or method 600 is performed by the memory sub-system controller 115 of FIG. 1 based on the CAM-enabled data de-duplicator 113. Additionally, or alternatively, for some embodiments, at least some portion of method 500 or method 600 is performed, at least in part, by the local media controller 135 of the memory device 130 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

Referring now to method 500 of FIG. 5, at operation 502, a processing device (e.g., the processor 117 of a memory sub-system controller 115) receives a new data object that is intended for storage on non-content-addressable memory (non-CAM). For example, the processor can receive the new data object from a host system (e.g., 120) operatively coupled to the memory sub-system (e.g., 110) that is performing operation 502. In response to receiving the new data object, and prior to the new data object being stored on the non-CAM, method 500 proceeds from operation 502 to operation 506, where operations 506 through 516 can be performed prior to the new data object being stored on the non-CAM.

Alternatively or additionally, at operation 504, the processing device (e.g., the processor 117) monitors for when data objects are generated for storage on non-content-addressable memory (non-CAM) of the memory sub-system. In response to detecting a new data object being generated for storage on the non-CAM, and prior to the new data object being stored on the non-CAM, method 500 proceeds from operation 504 to operation 506, where operations 506 through 516 can be performed prior to the new data object being stored on the non-CAM.

Depending on the embodiment, a data object can comprise a file or a portion thereof, a database object or a portion thereof, a word of data, a superblock of data, a block of data, or a page of data. Additionally, depending on the embodiment, the non-CAM can be part of the current memory sub-system (e.g., 110) that is performing operation 502 or, where the current memory sub-system (e.g., 110) is merely used to perform duplicate data detection, the non-CAM can be external to the current memory sub-system (e.g., can be part of another memory sub-system). For some embodiments, the non-CAM comprises a plurality of non-CAM blocks. At least one non-CAM block of the plurality of non-CAM blocks can be either a single-level cell (SLC) block, a multi-level cell (MLC) block, a triple-level cell (TLC) block, or a quad-level cell (QLC) block. For some embodiments, the CAM and the non-CAM are located on the same memory sub-system, where the CAM (e.g., CAM blocks) and non-CAM (e.g., non-CAM blocks) are partitioned from each other. For example, where the CAM and the non-CAM are part of the same memory sub-system, at least some portion of the CAM (e.g., at least one CAM block) and at least some portion of the non-CAM (e.g., at least one non-CAM block) can be part of a single memory device of the memory sub-system. Alternatively, where the CAM and the non-CAM are part of the same memory sub-system, the CAM (e.g., all CAM blocks) can be on a first set of memory devices of the memory sub-system, and non-CAM (e.g., all CAM blocks) can be on a second set of memory devices of the memory sub-system separate from the first set.

At operation 506, the processing device (e.g., the processor 117) generates a new unique identifier for the new data object. According to some embodiments, during operation 506, the processor generates a hash value (e.g., cryptographic hash value) of the new data object. The processor can use, for example, SHA-256 to generate a 256-byte hash value of the new data object. An embodiment can generate the hash value of the new data object using any algorithm that generates a “strong” hash of the new data object (e.g., “strong” hash value to avoid hash value collision for two different data objects).

After the unique identifier is generated for the new data object, at operation 508, the processing device (e.g., the processor 117) performs a search for the new unique identifier on a content-addressable memory (CAM) (e.g., 160) of the memory sub-system. For some embodiments, the CAM comprises a plurality of CAM blocks. Additionally, for some embodiments, the CAM is implemented on one or more NAND-type memory devices. An example of such an implementation is illustrated and described with respect to FIGS. 2 through 4. Alternatively, for some embodiments, the CAM is implemented on one or more NOR-type or MRAM-type memory devices. Use of a CAM implemented on one or more NAND-type memory devices can facilitate a quick search of the new unique identifier (e.g., the new hash value) of the new data object (e.g., the new unique identifier can be compared against 512k 256-byte hash values simultaneously in less than 100 microseconds). During operation 508, the processing device can use the new unique identifier (generated for the new data object at operation 506) as an input search word to the CAM. A search component (e.g., 150) of a memory device (e.g., 130) can generate a search pattern based on the input search word received from the processor, can input the search pattern vertically along search lines of one or more CAM blocks of the CAM (e.g., 160). If a data entry matching the input search word is stored by at least one of the one or more CAM blocks (e.g., a matching unique identifier is found), the search pattern causes a match line storing the data entry (e.g., the matched line) to become conductive, which provides a signal to a connected page buffer that indicates that the search word is stored thereon. The page buffer connected to any matched line stores a datum in response to detecting a discharge signal that indicates that the matched datum is stored along the matched line. The search component 150 can read data from the page buffer. Based on the data read from the page buffer, the search component 150 outputs an indication of whether the input search word (i.e., the new unique identifier being searched for) is stored by the one or more CAM blocks, and can also output an indicator of the location of the match line.

At operation 510, the processing device (e.g., the processor 117) determines whether the search indicates that the new unique identifier is stored on the CAM. For example, the processing device can make this determination based on whether a search component (e.g., 150) used to facilitate the search of the CAM indicates that the new unique identifier is stored by the CAM.

In response to the processing device determining that the search indicates that the new unique identifier is not stored on the CAM, method 500 proceeds to operation 512. At operation 512, the processing device causes the new data object to be stored on the non-CAM and, at operation 514, the processing device causes the new unique identifier to be stored on the CAM. Where the memory sub-system comprises a volatile memory, the new data object received or generated can be stored on the volatile memory prior to being stored on the non-CAM, and the processing device (of the memory sub-system) can cause the new data object to be stored on the non-CAM by copying the new data object from the volatile memory device to the non-CAM. Where the new data object is received by the memory sub-system (e.g., 110) from a host system (e.g., 120) operatively coupled to the memory sub-system, and the non-CAM is external to the memory sub-system, the processing device (of the memory sub-system) can cause the new data object to be stored on the non-CAM by sending an indication to the host system that no data object currently stored on the non-CAM is a duplicate of the new data object. In response to receiving such an indication, the host system can store or cause storage of the new data object on the non-CAM.

In response to the processing device determining that the search indicates that the new unique identifier is stored on the CAM, method 500 proceeds to operation 516, where the processing device causes the new data object to be deleted without the new data object being stored on the non-CAM. Effectively, by operation 516, the processing device foregoes storage of the new data object on the non-CAM. Where the memory sub-system comprises a volatile memory, the new data object received or generated can be stored on the volatile memory prior to being stored on the non-CAM, and the processing device (of the memory sub-system) can cause the new data object to be deleted without the new data object being stored on the non-CAM by deleting the new data object from the volatile memory device. Where the new data object is received by the memory sub-system (e.g., 110) from a host system (e.g., 120) operatively coupled to the memory sub-system, and the non-CAM is external to the memory sub-system, the processing device (of the memory sub-system) can cause the new data object to be deleted without the new data object being stored on the non-CAM by sending an indication (e.g., signal) to the host system that a select data object currently stored on the non-CAM is a duplicate of the new data object. In response to receiving such an indication, the host system can forego storing or causing storage of the new data object on the non-CAM.

Depending on the embodiment, operations 506 through 516 of method 500 can repeat for each new data object received that is intended for storage on the non-CAM, or can repeat for each new data object generated for storage on the non-CAM.

Referring now to method 600 of FIG. 6, in comparison to method 500 of FIG. 5, method 600 illustrates where data objects are initially stored on non-CAM and later deleted from the non-CAM if any of the data objects are identified to be duplicate data. At operation 602, a processing device (e.g., the processor 117 of a memory sub-system controller 115) receives a new data object for storage from a host system, where the memory sub-system comprises a set of memory devices, and where the set of memory devices comprises CAM and non-CAM. In response to receiving the new data object from the host system, the processing device stores the new data object on the non-CAM. At operation 606, the processing device generates a new unique identifier for the new data object and, at operation 608, the processing device stores the new unique identifier on the CAM. Subsequently, during operation 610, either a processing device of the memory sub-system, or the host system, performs a data de-duplication process on the memory sub-system. For instance, a data processing unit (DPU) of the host system could perform (or cause the performance of) the data de-duplication process on the memory sub-system. For various embodiments, the data de-duplication process is configured to use one or more unique identifiers stored on the CAM memory to identify one or more duplicate data objects stored on the non-CAM memory, and delete at least one of the one or more duplicate data objects.

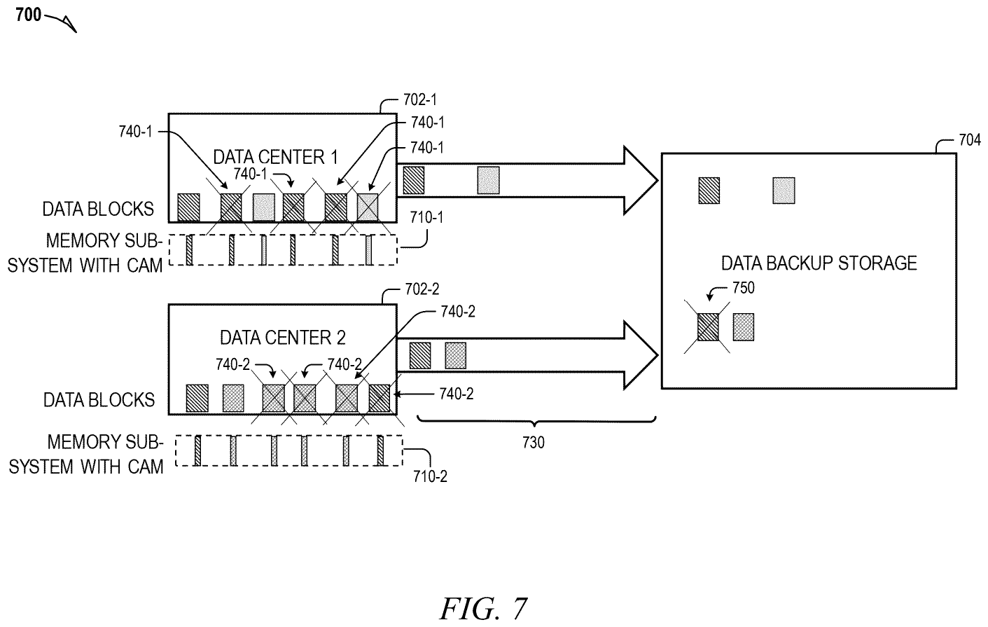

FIG. 7 is a block diagram illustrating an example of using data search on CAM to facilitate data de-duplication in an example data center environment 700, in accordance with some embodiments of the present disclosure. As shown, the data center environment 700 comprises data centers 702-1, 702-2 and a data backup storage 704. Each of the data centers 702-1, 702-2 can be considered a different data source and can comprise one or more front-end or edge servers. The data backup storage 704 can comprise one or more data backup servers or systems, and can represent a data backup or data archive facility that is physically located at a location remote from the data centers 702-1, 702-1. FIG. 7 illustrates how use of data de-duplication using a CAM as described herein can be performed at the data source/edge, thereby not only reducing the amount of data that is stored at the source/edge (e.g., each of the data centers 702-1, 702-2), but also reducing the amount of data 730 that is transmitted over a data communication network to the data backup storage 704 during a data backup operation. As shown, each of the data centers 702-1, 702-2 receive or generate data blocks, generate unique identifiers (e.g., hash values) of those data blocks, and store the generated unique identifiers on their respective memory sub-systems with CAM 710-1, 710-2. Each of the memory sub-systems 710-1, 710-2 can represent an individual memory sub-system that includes CAM as described herein. Depending on the embodiment, each of the memory sub-systems 710-1, 710-2 can also include non-CAM that stores data blocks for its respective data center or, alternatively, the data blocks of the respective data centers are stored on non-CAM of a memory sub-system that is different from the memory sub-systems 710-1, 710-2. According to some embodiments, the CAM of the memory sub-system 710-1 enables the data center 702-1 to detect duplicate data blocks 740-1 (e.g., as they are received or generated) and delete from such duplicates from the data center 702-1. The data center 702-1 can also do the same (with respect to its duplicate data blocks 740-2) using the CAM of its respective memory sub-system 710-2. Additionally, as shown, the data backup storage 704 can further reduce data stored by performing its own data de-duplication (e.g., deletion of duplicate data block 750). Though not illustrated, the data backup store 704 can also use an embodiment described herein for performing data de-duplication using data search on a CAM.

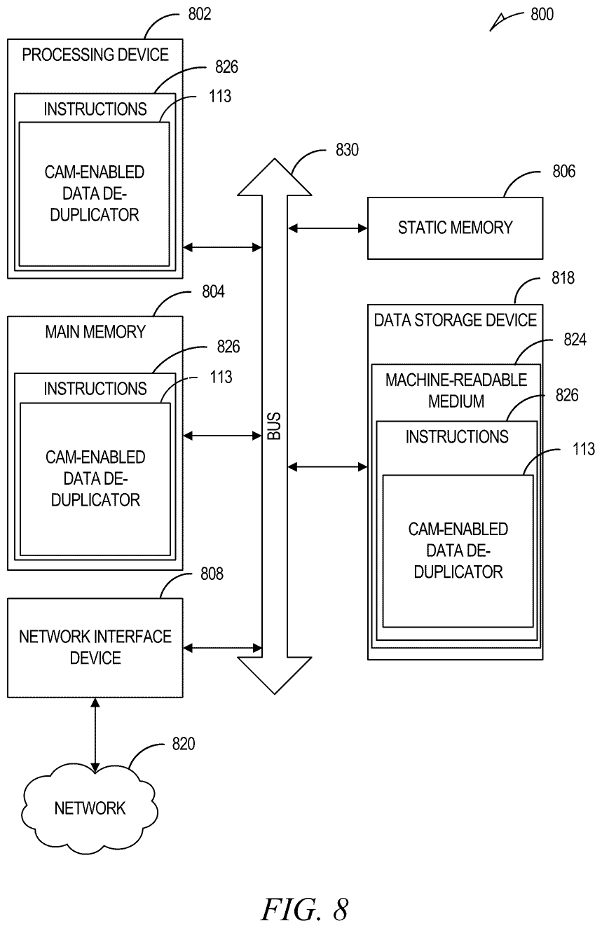

FIG. 8 illustrates an example machine in the form of a computer system 800 within which a set of instructions can be executed for causing the machine to perform any one or more of the methodologies discussed herein. In some embodiments, the computer system 800 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., ROM, flash memory, DRAM such as SDRAM or Rambus DRAM (RDRAM), etc.), a static memory 806 (e.g., flash memory, static random access memory (SRAM), etc.), and a data storage device 818, which communicate with each other via a bus 830.

The processing device 802 represents one or more general-purpose processing devices such as a microprocessor, a central processing unit, or the like. More particularly, the processing device 802 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 802 can also be one or more special-purpose processing devices such as an application-specific integrated circuit (ASIC), a field programmable gate array (FPGA), a digital signal processor (DSP), a network processor, or the like. The processing device 802 is configured to execute instructions 826 for performing the operations and steps discussed herein. The computer system 800 can further include a network interface device 808 to communicate over a network 820.

The data storage device 818 can include a machine-readable storage medium 824 (also known as a computer-readable medium) on which is stored one or more sets of instructions 826 or software embodying any one or more of the methodologies or functions described herein. For some embodiments, the machine-readable storage medium 824 is a non-transitory machine-readable storage medium. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage device 818, and/or main memory 804 can correspond to the memory sub-system 110 of FIG. 1.

In one embodiment, the instructions 826 include instructions to implement functionality corresponding to using data search on CAM to facilitate data de-duplication as described herein (e.g., the CAM-enabled data de-duplicator 113 of FIG. 1). While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a set of non-volatile memory devices comprising content-addressable memory (CAM); and a processing device, operatively coupled to the set of non-volatile memory devices, configured to perform operations comprising: receiving a new data object that is intended for storage on non-content-addressable memory (non-CAM); and in response to receiving the new data object and prior to the new data object being stored on the non-CAM: generating a new unique identifier for the new data object; performing a search for the new unique identifier on the CAM; and in response to the search indicating that the new unique identifier is stored on the CAM, causing the new data object to be deleted without the new data object being stored on the non-CAM.

In Example 2, the subject matter of Example 1 includes, wherein the system is a memory sub-system, wherein the new data object is received from a host system operatively coupled to the memory sub-system, wherein the non-CAM is external to the memory sub-system, and wherein the causing of the new data object to be deleted without the new data object being stored on the non-CAM comprises: sending an indication to the host system that a select data object currently stored on the non-CAM is a duplicate of the new data object.

In Example 3, the subject matter of Examples 1-2 includes, wherein the operations comprise: prior to the new data object being stored on the non-CAM: in response to the search indicating that the new unique identifier is not stored on the CAM: causing the new data object to be stored on the non-CAM; and causing the new unique identifier to be stored on the CAM.

In Example 4, the subject matter of Example 3 includes, wherein the set of non-volatile memory devices comprises the non-CAM.

In Example 5, the subject matter of Example 4 includes, wherein the system comprises a volatile memory device, wherein the receiving of the new data object comprises storing the new data object on the volatile memory device, and wherein the causing of the new data object to be stored on the non-CAM comprises: copying the new data object from the volatile memory device to the non-CAM.

In Example 6, the subject matter of Examples 3-5 includes, wherein the system is a memory sub-system, wherein the new data object is received from a host system operatively coupled to the memory sub-system, wherein the non-CAM is external to the memory sub-system, and wherein the causing of the new data object to be stored on the non-CAM comprises: sending an indication to the host system that no data object currently stored on the non-CAM is a duplicate of the new data object.

In Example 7, the subject matter of Examples 1-6 includes, wherein system comprises a volatile memory device, wherein the receiving of the new data object comprises storing the new data object on the volatile memory device, and wherein the causing of the new data object to be deleted without the new data object being stored on the non-CAM comprises: deleting the new data object from the volatile memory device.

In Example 8, the subject matter of Examples 1-7 includes, wherein the CAM comprises a plurality of CAM blocks.

In Example 9, the subject matter of Example 8 includes, wherein the non-CAM comprises a plurality of non-CAM blocks.

In Example 10, the subject matter of Example 9 includes, wherein at least one non-CAM block of the plurality of non-CAM blocks is either a single-level cell (SLC) block, a multi-level cell (MLC) block, a triple-level cell (TLC) block, or a quad-level cell (QLC) block.

In Example 11, the subject matter of Examples 9-10 includes, wherein at least one CAM block of the plurality of CAM blocks and at least one non-CAM block of the plurality of non-CAM blocks are on a same memory device in the set of memory devices.

In Example 12, the subject matter of Examples 9-11 includes, wherein the plurality of CAM blocks is on a first subset of the set of memory device, and wherein the plurality of non-CAM blocks is on a second subset of the set of memory devices.

In Example 13, the subject matter of Examples 1-12 includes, wherein the generating of the new unique identifier for the new data object comprises: generating a new hash value for the new data object.

In Example 14, the subject matter of Examples 1-13 includes, wherein the CAM is implemented on one or more NAND-type memory devices of the set of non-volatile memory devices.

In Example 15, the subject matter of Examples 1-14 includes, wherein the CAM comprises a plurality of CAM blocks, wherein an individual CAM block of the plurality of CAM blocks comprises an array of memory cells organized into a plurality of strings, wherein a string in the plurality of strings stores a data entry, wherein the string comprises a plurality of memory cells connected in series between a pre-charged match line and a page buffer, and wherein each of the memory cells is connected to one of a plurality of search lines.

Example 16 is at least one machine-readable medium including instructions that, when executed by a processing device of a memory sub-system, cause the processing device to perform operations to implement of any of Examples 1-15.

Example 17 is a method to implement of any of Examples 1-15.

Example 18 is at least one non-transitory machine-readable storage medium comprising instructions that, when executed by a processing device of a memory sub-system, cause the processing device to perform operations comprising: monitor for when data objects are generated for storage on non-content-addressable memory (non-CAM) of the memory sub-system; and in response to detecting a new data object being generated for storage on the non-CAM and prior to the new data object being stored on the non-CAM: generating a new unique identifier for the new data object; performing a search for the new unique identifier on a content-addressable memory (CAM) of the memory sub-system; and in response to the search indicating that the new unique identifier is not stored on the CAM: causing the new data object to be stored on the non-CAM; and causing the new unique identifier to be stored on the CAM.

Example 19 is a system to implement Example 18.

Example 20 is a method to implement Example 18.

Example 21 is a method comprising: receiving, at a memory sub-system, a new data object for storage from a host system, the memory sub-system comprising a set of memory devices, the set of memory devices comprising content-addressable memory (CAM) and non-CAM; storing, by the memory sub-system, the new data object on the non-CAM; generating, by the memory sub-system, a new unique identifier for the new data object; and storing, by the memory sub-system, the new unique identifier on the CAM.

In Example 22, the subject matter of Example 21 includes, performing, by the host system, a data de-duplication process on the memory sub-system, the data de-duplication process being configured to use one or more unique identifiers stored on the CAM memory to: identify one or more duplicate data objects stored on the non-CAM memory; and delete at least one of the one or more duplicate data objects.

In Example 23, the subject matter of Examples 21-22 includes, performing, by the memory sub-system, a data de-duplication process on the memory sub-system, the data de-duplication process being configured to use one or more unique identifiers stored on the CAM memory to: identify one or more duplicate data objects stored on the non-CAM memory; and delete at least one of the one or more duplicate data objects.

In Example 24, the subject matter of Examples 21-23 includes, wherein the set of memory devices comprises at least one NAND-type memory device, and wherein the CAM is implemented on the at least one NAND-type memory device.

Example 25 is at least one machine-readable medium including instructions that, when executed by processing circuitry, cause the processing circuitry to perform operations to implement of any of Examples 21-24.

Example 26 is a system to implement of any of Examples 21-24.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMS, EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (e.g., non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a set of non-volatile memory devices comprising content-addressable memory (CAM); and
a processing device, operatively coupled to the set of non-volatile memory devices, configured to perform operations comprising:
receiving a new data object that is intended for storage on non-content-addressable memory (non-CAM); and
in response to receiving the new data object and prior to the new data object being stored on the non-CAM:
generating a new unique identifier for the new data object;
performing a search for the new unique identifier on the CAM; and
in response to the search indicating that the new unique identifier is stored on the CAM, causing the new data object to be deleted without the new data object being stored on the non-CAM.

2. The system of claim 1, wherein the system is a memory sub-system, wherein the new data object is received from a host system operatively coupled to the memory sub-system, wherein the non-CAM is external to the memory sub-system, and wherein the causing of the new data object to be deleted without the new data object being stored on the non-CAM comprises:
sending an indication to the host system that a select data object currently stored on the non-CAM is a duplicate of the new data object.

3. The system of claim 1, wherein the operations comprise:
prior to the new data object being stored on the non-CAM:
in response to the search indicating that the new unique identifier is not stored on the CAM:
causing the new data object to be stored on the non-CAM; and
causing the new unique identifier to be stored on the CAM.

4. The system of claim 3, wherein the set of non-volatile memory devices comprises the non-CAM.

5. The system of claim 4, wherein system comprises a volatile memory device, wherein the receiving of the new data object comprises storing the new data object on the volatile memory device, and wherein the causing of the new data object to be stored on the non-CAM comprises:
copying the new data object from the volatile memory device to the non-CAM.

6. The system of claim 3, wherein the system is a memory sub-system, wherein the new data object is received from a host system operatively coupled to the memory sub-system, wherein the non-CAM is external to the memory sub-system, and wherein the causing of the new data object to be stored on the non-CAM comprises:
sending an indication to the host system that no data object currently stored on the non-CAM is a duplicate of the new data object.

7. The system of claim 1, wherein the system comprises a volatile memory device, wherein the receiving of the new data object comprises storing the new data object on the volatile memory device, and wherein the causing of the new data object to be deleted without the new data object being stored on the non-CAM comprises:
deleting the new data object from the volatile memory device.

8. The system of claim 1, wherein the CAM comprises a plurality of CAM blocks.

9. The system of claim 8, wherein the non-CAM comprises a plurality of non-CAM blocks.

10. The system of claim 9, wherein at least one non-CAM block of the plurality of non-CAM blocks is either a single-level cell (SLC) block, a multi-level cell (MLC) block, a triple-level cell (TLC) block, or a quad-level cell (QLC) block.

11. The system of claim 9, wherein at least one CAM block of the plurality of CAM blocks and at least one non-CAM block of the plurality of non-CAM blocks are on a same memory device in the set of memory devices.

12. The system of claim 9, wherein the plurality of CAM blocks is on a first subset of the set of memory device, and wherein the plurality of non-CAM blocks is on a second subset of the set of memory devices.

13. The system of claim 1, wherein the generating of the new unique identifier for the new data object comprises:
generating a new hash value for the new data object.

14. The system of claim 1, wherein the CAM is implemented on one or more NAND-type memory devices of the set of non-volatile memory devices.

15. The system of claim 1, wherein the CAM comprises a plurality of CAM blocks, wherein an individual CAM block of the plurality of CAM blocks comprises an array of memory cells organized into a plurality of strings, wherein a string in the plurality of strings stores a data entry, wherein the string comprises a plurality of memory cells connected in series between a pre-charged match line and a page buffer, and wherein each of the memory cells is connected to one of a plurality of search lines.

16. At least one non-transitory machine-readable storage medium comprising instructions that, when executed by a processing device of a memory sub-system, cause the processing device to perform operations comprising:
monitor for when data objects are generated for storage on non-content-addressable memory (non-CAM) of the memory sub-system; and
in response to detecting a new data object being generated for storage on the non-CAM and prior to the new data object being stored on the non-CAM:
generating a new unique identifier for the new data object;
performing a search for the new unique identifier on a content-addressable memory (CAM) of the memory sub-system; and
in response to the search indicating that the new unique identifier is not stored on the CAM:
causing the new data object to be stored on the non-CAM; and
causing the new unique identifier to be stored on the CAM.

17. A method comprising:
receiving, at a memory sub-system, a new data object for storage from a host system, the memory sub-system comprising a set of memory devices, the set of memory devices comprising content-addressable memory (CAM) and non-CAM;
storing, by the memory sub-system, the new data object on the non-CAM;
generating, by the memory sub-system, a new unique identifier for the new data object; and
storing, by the memory sub-system, the new unique identifier on the CAM.

18. The method of claim 17, comprising:
performing, by the host system, a data de-duplication process on the memory sub-system, the data de-duplication process being configured to use one or more unique identifiers stored on the CAM memory to:
identify one or more duplicate data objects stored on the non-CAM memory; and
delete at least one of the one or more duplicate data objects.

19. The method of claim 17, comprising:
performing, by the memory sub-system, a data de-duplication process on the memory sub-system, the data de-duplication process being configured to use one or more unique identifiers stored on the CAM memory to:
identify one or more duplicate data objects stored on the non-CAM memory; and
delete at least one of the one or more duplicate data objects.

20. The method of claim 17, wherein the set of memory devices comprises at least one NAND-type memory device, and wherein the CAM is implemented on the at least one NAND-type memory device.
